(19) United States
(12) Patent Application Publication
(10) Pub. No.: US 2009/0089278 A1
(43) Pub. Date: Apr. 2, 2009

(54) TECHNIQUES FOR KEYWORD EXTRACTION FROM URLS USING STATISTICAL ANALYSIS

(76) Inventors: Krishna Leela Poola, Bangalore (IN); Arun Ramanujapuram, Bangalore (IN)

Correspondence Address: HICKMAN PALERMO TRUONG & BECKER LLP/Yahoo! Inc., 2055 Gateway Place, Suite 550, San Jose, CA, 95110-1083, US

(21) Appl. No.: 11/937,417

(22) Filed: Nov. 8, 2007

(30) Foreign Application Priority Data
Sep. 27, 2007 (IN) 2177/CHE/2007

(51) Int. Cl. G06F 7/06

(52) U.S. Cl. 707/5; 707/E17.014

(57) ABSTRACT

Techniques are described for keyword extraction from URLs using regular expression patterns and keyword ranking. Tokenization of URLs also generates regular expressions of URLs from a website. The regular expressions are stored in the form of any type of indexing structure. When a new URL is received, the URL is examined to determine whether the URL is from a website that has previously been tokenized. If the URL is not from such a website, then the URL is tokenized using every delimiter and unit change to extract keywords. If the URL is from a website previously processed, the corresponding regular expression is used to extract keywords from the URL. The keywords extracted from the URLs are then ranked based on any ranking methodology for better relevance and performance.

### CROSS REFERENCE TO RELATED APPLICATIONS

This application claims the benefit of priority from Indian Patent Application No. 2177/CHE/2007 filed in India on Sep. 27, 2007, entitled “TECHNIQUES FOR KEYWORD EXTRACTION FROM URLS USING STATISTICAL ANALYSIS”; the entire content of which is incorporated herein by this reference thereto and for all purposes as if fully disclosed herein.

This application is related to U.S. patent application Ser. No. 11/935,622 filed on Nov. 6, 2007, entitled “TECHNIQUES FOR TOKENIZING URLS” which is incorporated by reference in its entirety for all purposes as if originally set forth herein.

### FIELD OF THE INVENTION

The present invention relates to keyword extraction for web documents.

### BACKGROUND

As the popularity and size of the Internet has grown, categorizing and extracting information on the Internet has become difficult and resource intensive. This information is difficult to categorize and manage because of the size and complexity of the Internet. Furthermore, the information comprising the Internet continues to grow and change each day. Categorizing information on the Internet may be based upon many criteria. For example, information might be categorized by the content of the information in a web document. If a user searches for specific content, then the user may enter a keyword into a search engine and web documents that relate to the keyword are returned to the user. Unfortunately, determining content by analyzing each web document requires large amounts of computing resources. As a result, more efficient and faster methods to categorize and extract information from the Internet are very important.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagram of a URL and the URL's components, according to an embodiment of the invention;

FIG. 2 is a diagram of a regular expression, according to an embodiment of the invention;

FIG. 3 is a flowchart of steps to perform keyword extraction using statistical analysis, according to an embodiment of the invention; and

FIG. 4 is a block diagram of a computer system on which embodiments of the invention may be implemented.

### DETAILED DESCRIPTION

Techniques are described to process URLs, in a URL corpus, that have been tokenized. In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

To manage and categorize information on the Internet, web documents may be classified and ranked based upon keywords. As used herein, “keywords” refers to particular words that indicate the subject matter or content of a web document. For example, a web document about portable computers from a computer manufacturer might be categorized under the keyword “laptop”. In addition to helping to manage information, keywords allow Internet search engines to locate and list web documents that correspond to the keyword.

Keywords may be generated from a variety of sources including, but not limited to, the web document itself and the URL of the document. In an embodiment, keywords are extracted from the web document itself. This may be performed by analyzing the entire text of a particular web document and selecting words that summarize or indicate the subject matter of the particular web document. However, extracting keywords from a web document may lead to high computing resource costs and problems with scalability. For example, while processing the text of a single web document might not use many resources, scaling the process to include all of the web documents on the Internet is an extremely resource-intensive task.

In an embodiment, keywords are extracted from the URL of a web document. A URL is first tokenized into candidate keywords based on a tokenization algorithm. Once the candidate keywords are identified, the candidate keywords are ranked based on relevance and performance. The ranked keywords may then be used for managing and categorizing information on the Internet. Extracting keywords from the URL of a web document is highly scalable and less resource-intensive than extracting keywords from the web document itself because the amount of information processed is significantly less.

### URLs

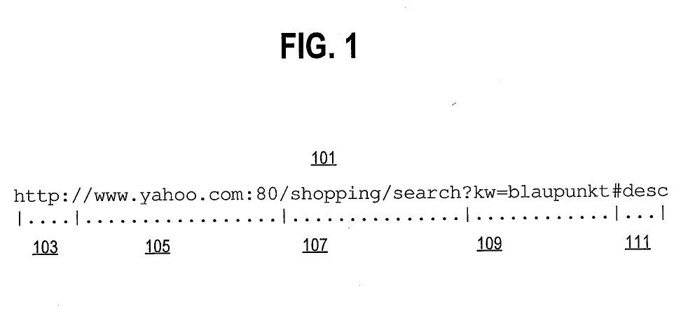

A uniform resource locator (URL) is the global address of web documents and resources located on the Internet. Each web document or resource on the Internet is mapped to one or more particular URLs. To locate and retrieve a particular document, the URL of the document may be entered into a web browser or other information retrieval application. In response, the document is retrieved. An example of a URL is illustrated in FIG. 1. In FIG. 1, URL 101 is shown as “http://www.yahoo.com:80/shopping/search?kw=blaupunkt#desc”. URLs are composed of five different components: (1) the scheme 103, (2) the authority 105, (3) the path 107, (4) query arguments 109, and (5) fragments 111.

Each component of a URL provides different functions. Scheme 103 identifies the protocol to be used to access a resource on the Internet. Two examples of protocols that may be used are “HTTP” and “FTP”. Hypertext Transfer Protocol (“HTTP”) is a communications protocol used to transfer or convey information on the World Wide Web. File Transfer Protocol (“FTP”) is a communications protocol used to transfer data from one computer to another over the Internet, or through a network. Authority 105 identifies the host server that stores the web documents or resources. A port number may follow the host name in the authority and is preceded by a single colon “:”. Port numbers are used to identify data associated with a particular process in use by the web server. In FIG. 1, the port number is “80”. Path 107 identifies the specific resource or web document within a host that a client wishes to access. The path component begins with a slash character “/”. Query arguments 109 provide a string of information that may be used as parameters for a search or as data to be processed. Query arguments comprise a string of name and value pairs. In FIG. 1, query argument 109 is “kw=blaupunkt”. The query parameter name is “kw” and the value of the parameter is “blaupunkt”. Fragments 111 are used to direct a web browser to a reference or function within a web document. The separator used between query arguments and fragments is the “#” character. For example, a fragment may be used to indicate a subsection within the web document. In FIG. 1, fragment 111 is shown as “#desc”. The “desc” fragment may reference a subsection in the web document that contains a description.

URLs often indicate the subject matter or content of the web document that the URL is references. For example, the URL “http://www.myspacenow.com/cartoons-looneytunes 1.shtml” might indicate that the content of the web document is about “cartoons” or more specifically, the cartoon “Looney Tunes”. Tokenizing URLs and using the tokens as keywords to categorize web documents is an efficient technique to manage and extract information on the Internet. Any method may be used to tokenize URLs. One method to tokenizing URLs is further described in the U.S. patent application, “TECHNIQUES FOR TOKENIZING URLs” which is incorporated herein by reference.

In addition to categorizing and managing information on the Internet, extracting keywords from the URL has use in other applications. For example, advertisements may be generated for a web document based on the keywords extracted from the document's URL. The tokens generated by URL tokenization may also be assigned with features of the web document to improve the efficiency of a web search. Tokenizing URLs is also the first step when clustering URLs of a website. Clustering URLs allows the identification of portions of web documents that hold more relevance. Thus, when a website is crawled by a search engine, some portions of web documents may be white-listed and should be crawled, while other portions may be black-listed and should not be crawled. This leads to more efficient web crawling.

### Regular Expressions

Tokenizing URLs results not only in keywords extracted from URLs, but also in regular expressions that match URLs. As used herein, a regular expression is a string that is used to describe or match a set of strings, according to certain syntax rules. A regular expression matches a set of URLs from which the expression itself is generated.

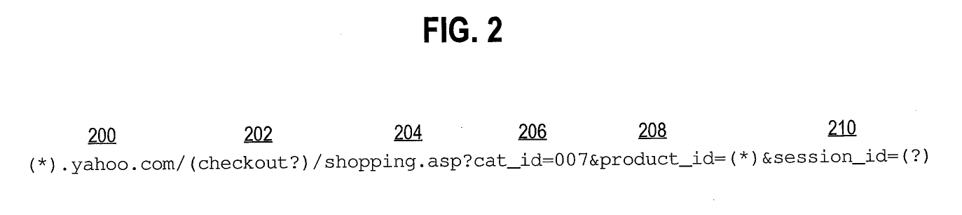

An example of a regular expression generated for “www.yahoo.com” appears in FIG. 2. In an embodiment, a regular expression for a URL has the following components: (1) “Start Marker,” (2) “Host Name,” (3) “Path,” (4) “Script,” and (5) “Query Arguments”. Some of these components are comprised of sub-components. For example, the second component, “Host Name,” might comprise a domain and multiple sub-domains. The “Path” component may comprise of a sequence of directories and a file-name. The component, “Query Arguments,” may comprise a key, an indicator showing the presence or absence for a value, and a value.

In an embodiment, special markers exist between the components of the regular expression indicating certain patterns. For example, the symbol “(*)” might indicate that the current token is not to be considered. If the token is not to be considered, then a look-ahead is used to find the next available token. The symbol “(?)” might indicate that a particular token is optional. The symbol “SKIP” might indicate that a jump is to be made to the next URL component. For example, if the symbol “SKIP” is specified in the component “Path,” then the next URL component for matching is considered. Under this circumstance, the next component is “Query Arguments”. Special markers might also mark the start and end of every component. Any other symbols may also be used to indicate other patterns in the regular expression.

In FIG. 2, the first special marker, “(*),” located in the domain component, “(*).yahoo.com” 200, denotes that any token at the start of the domain name matches the expression. Thus, the sub-domains “shopping.yahoo.com” or “travel.yahoo.com” would match this expression. A second special marker, “(?),” is located in the path, “(checkout?)” 202. The second special marker means that the token “checkout” is optional. Thus, this regular expression would match any URL with or without the “checkout” token as long as other tokens of the URL correspond to the regular expression. No special marker is present for the path “shopping.asp” 204. The third special marker, “(*),” in the query argument “product_id=(*)” 208, denotes that URLs with any value for “product id” would match this portion of the regular expression. For example, the query arguments, “product_id=‘1234’,” and “product_id=‘FOO’,” would both match the regular expression. No special marker is present for the argument query, “cat_id=007” 208. The fourth special marker, “(?),” is located in the argument query “session_id=(?)” 210. The special marker “(?),” means that the value for the parameter “session_id” is optional. Thus, any URL with or without a value for the parameter “session_id” would match the regular expression.

In an embodiment, regular expressions generated from the URL corpus are stored in standard index structures able to index strings and regular expressions. For example, the regular expressions might be stored as a suffix tree, a trie, a prefix tree or any other type of indexing structure. Regular expressions may also be stored in custom index structures. The index may then be used to tokenize and extract possible keywords from URLs of known websites and unknown websites. A “website” refers to a collection of web documents that are hosted on one or more web servers. The pages of a website may be accessed from a common root URL with other URLs of the website organized into a hierarchy.

Any technique for efficiently storing and indexing regular expressions may be used, including custom index structures. Further information on efficiently storing and indexing regular expressions may be found in the reference, “RE-Tree: An Efficient Index Structure for Regular Expressions” by Chee-Yong Chan, Minos Garofalakis, and Rajeev Rastogi (28th International Conference on Very Large Data Bases (VLDB), Hong Kong, China. Aug. 20-23, 2002) and the reference “A Fast Regular Expression Indexing Engine” by Junghoo Cho and Sridhar Rajagopalan (Technical report, UCLA Computer Science Department, http://oak.cs.ucla.edu/˜cho/papers/cho-regex.pdf, 2001), both of which are incorporated herein by reference.

Regular expressions and tokens stored in an indexing structure allow linear time mapping of URLs to corresponding regular expressions. The regular expression is then able to generate tokens based upon matches made to a URL. For example, a newly received URL is matched to corresponding regular expressions stored in the indexing structure using any type of index-specific search algorithm. The regular expression is then used to extract keywords from the URL

### Online Keyword Extraction from URLs Matching a Regular Expression

Online keyword extraction refers to a new URL being received and tokenized in order to extract keywords. In an embodiment, when a URL is received, the index structure that stores the regular expressions is searched in order to extract a corresponding regular expression. Any type of index searching algorithm may be used. The corresponding regular expression is then used to extract keywords from the URL.

The index structure may contain regular expressions that are (1) an exact, (2) a partial, or (3) no match to the received URL. An exact match occurs where the URL contains only patterns that match a corresponding regular expression. A partial match occurs if the received URL possesses patterns where only some of the patterns are found in a corresponding regular expression. No match occurs if the received URL has patterns that have not been indexed previously.

Online keyword extraction from URLs using regular expression is based upon a pre-existing index structure. As regular expressions are specific to a website, online keyword extraction may only be performed where tokenization and keyword extraction has previously been performed on the website. The previous keyword extraction may be viewed as a pre-processing and learning step on the URL corpus of websites. Thus, if tokenization and keyword extraction is performed on all URLs of all the domains on the web, then online keyword extraction may be performed with any URL from any domain.

### Keyword Extraction from a Single URL

URLs received that do not match patterns found in any regular expression within the index structure use other methods for keyword extraction. No pattern match occurs where URLs originate from websites that have not been previously processed. In an embodiment, keyword extraction from URLs with no match is accomplished through tokenization. Tokenization is based on finding every type of delimiter or unit change within the URL.

In an embodiment, a URL of a document is tokenized based upon generic delimiters and unit changes. As used herein, “generic delimiters” refers to characters that may be used to tokenize URLs of any website and are previously specified. The tokens of the URL are then analyzed and ranked to determine whether any of the tokens may be used as keywords.

In an embodiment, generic delimiters may include, but are not limited to, the characters “/,” “?,” “&,” and “=”. Each of the generic delimiters separate different components of a URL. For example, the character, “/,” separates the authority, path, and separate tokens of the path component of a URL. The character, “?,” separates the path component and the query argument component. The character, “&,” separates the query argument component of a URL into one or more parameter name and value pairs. The character, “=,” separates parameter names and parameter values in the query arguments component of the URL.

In an embodiment, a unit change is also used to determine delimiters in URLs. As used herein, a unit is a sequence of either letters from the alphabet or numbers. For example, in the sequence “256 MB,” “256” is one unit and “MB” is another unit. “256” is a unit because “256” is a sequence of numbers. “MB” is another unit because “MB” is a sequence of letters and not numbers. The change from one type of unit to another may define a website-specific delimiter. Tokenization based on this unit change would generate tokens “256” and “MB”.

The URL is tokenized based upon the above described delimiters and the resulting tokens may be used as keywords for the referenced web document. These keywords may then be processed in order to manage and categorize the information in the web document.

### Ranking Tokens

In an embodiment, in order to increase the performance and relevance of the extracted keywords or tokens, tokens are ranked based on specified criteria. Ranking is performed in order to separate “informative” from “noisy” tokens of the URLs. As used herein, “noisy” tokens refer to tokens that offer no relevance to the content of the corresponding web document. “Informative” tokens are those tokens that are relevant to the corresponding web document.

Ranking increases the relevance of the extracted tokens. This is important because tokens that are not relevant to the referenced content may lead to inaccurate results. For example, an application that matches advertisements based on extracted keywords might result in the placement of non-relevant advertisements. An advertisement for “cooking” on a sports-related website would not result in much interest.

Ranking tokens also improves performance because the number of tokens considered by an application is reduced. For example ranking keywords or tokens and then selecting only the top 10% of the results to be used to place advertisements would reduce the computing resources required to perform the task.

In an embodiment, ranking is performed by any known ranking technique for information extraction. For example, these techniques include, but are not limited to dictionaries, tf-idf, or mutual information. “tf-idf” (term frequency-inverse document frequency) is a statistical measure used to evaluate how important a word is to a document in a collection or corpus. The importance increases proportionally to the number of times a word appears in a document but is offset by the frequency of the word in the corpus. The mutual information of two random words is a measure of the mutual dependence of the two words in a corpus. Based upon these and other measures, ranking of the keywords may be performed.

### Example of Keyword Extraction based on Statistical Analysis

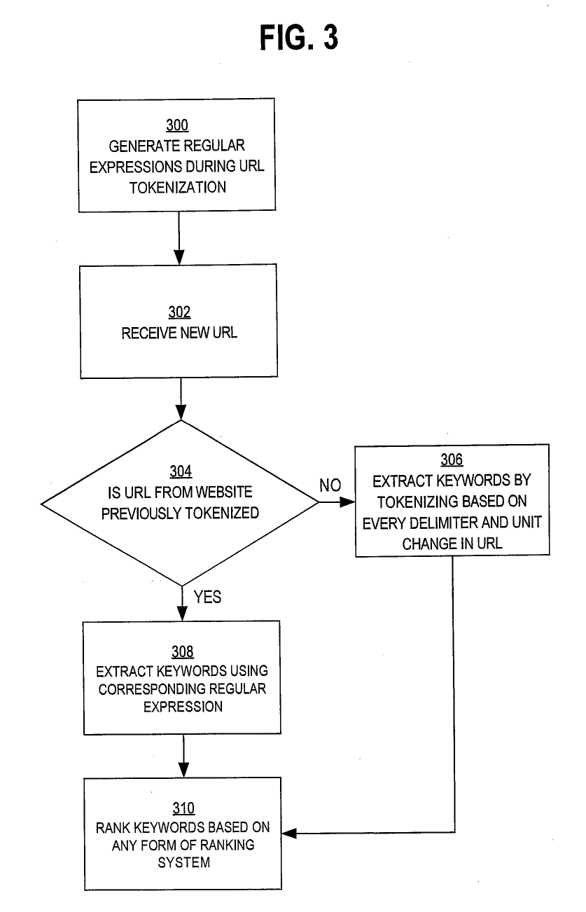

A diagram of a flowchart illustrating the steps to perform post-tokenization processing, according to an embodiment, is shown in FIG. 3. In step 300, pre-processing of the URL corpus occurs and with regular expressions generated of the URLs from websites processed. The regular expressions are stored in the form of an indexing structure so that the regular expressions may be quickly analyzed.

As an example, a first URL, “http://www.myspacenow.com/cartoons-looneytunes1.shtml” might be from a website not previously processed. A second URL, “http://www.laptop-computer-discounts.com/discount-amazon-cat-1205234-sku-B00006B7G9-item-256 mb-pc100_sdram_for_toshiba2,” might be from a previously processed website. In step 302, each of the URLs is received. In step 304, a determination is made as to whether the URLs received are from a website that has previously been processed. This may be determined by attempting to find the corresponding regular expression in the index structure. If no pattern match is found, then the website has not been processed. This may occur in the case of the first URL. In another embodiment, the domain of the URL received may be examined against a database of websites already examined.

If the URL (such as the first URL) is not from a website previously processed, then in step 306, tokenization is performed on the first URL. In tokenization, every delimiter and unit change is found in the URL in order to extract keywords. Thus, for “http://www.myspacenow.com/cartoons-looneytunes1.shtml,” tokens that would be extracted are “cartoons” and “looneytunes”. If the URL is from a website previously processed (such as the second URL), then in step 308, the corresponding regular expression from the indexing structure is used in order extract keywords from the second URL. For example, a search index algorithm is used to find the corresponding regular expression to the URL “http://www.laptop-computer-discounts.com/discount-amazon-cat-1205234-sku-B00006B7G9-item-256mb_pc100_sdram_for_toshiba2”. Using the corresponding regular expression, keywords are extracted from the URL. For example, the keywords “toshiba” and “amazon” might be extracted from the second URL. Finally, in step 310, the extracted keywords are ranked based on any form of ranking methodology in information theory in order to increase the efficiency and relevance of the keywords with respect to the websites. The rankings may be based on measures such as dictionaries or tf-idf.

### Hardware Overview

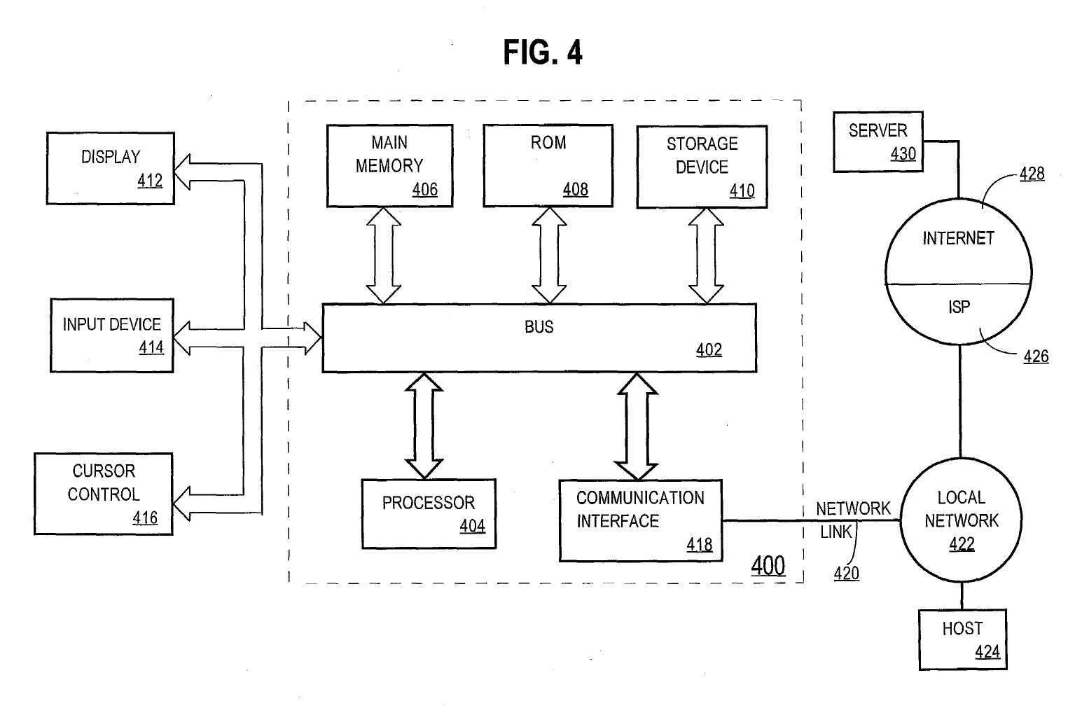

FIG. 4 is a block diagram that illustrates a computer system 400 upon which an embodiment of the invention may be implemented. Computer system 400 includes a bus 402 or other communication mechanism for communicating information, and a processor 404 coupled with bus 402 for processing information. Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

The invention is related to the use of computer system 400 for implementing the techniques described herein. According to one embodiment of the invention, those techniques are performed by computer system 400 in response to processor 404 executing one or more sequences of one or more instructions contained in main memory 406. Such instructions may be read into main memory 406 from another machine-readable medium, such as storage device 410. Execution of the sequences of instructions contained in main memory 406 causes processor 404 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 400, various machine-readable media are involved, for example, in providing instructions to processor 404 for execution. Such a medium may take many forms, including but not limited to storage media and transmission media. Storage media includes both non-volatile media and volatile media. Non-volatile media includes, for example, optical or magnetic disks, such as storage device 410. Volatile media includes dynamic memory, such as main memory 406. Transmission media includes coaxial cables, copper wire and fiber optics, including the wires that comprise bus 402. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 404 for execution. For example, the instructions may initially be carried on a magnetic disk of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are exemplary forms of carrier waves transporting the information.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution. In this manner, computer system 400 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method for post-tokenization processing, comprising:
generating, based upon tokenizations of a URL corpus, regular expressions for URLs in the URL corpus;
receiving a particular URL of a web document;
determining whether the particular URL corresponds to any of the regular expressions generated from the URL corpus;
if the particular URL does not correspond to any of the regular expressions generated from the URL corpus, then
(a) tokenizing, based on delimiters and unit changes, the particular URL, and
(b) storing each token of the particular URL as a keyword, thereby generating a first set of keywords;
if the particular URL corresponds to at least one of the regular expressions generated from the URL corpus, then
(a) retrieving a regular expression associated with the URL that corresponds to the particular URL, and (b) extracting, based upon the regular expression, keywords from the particular URL, thereby generating a second set of keywords;
ranking, based upon an information extraction algorithm, keywords from one of the first set and the second set, thereby producing a ranked set; and
storing the ranked set.

2. The method of claim 1, wherein delimiters comprise “/,” “?” “&,” and “=”.

3. The method of claim 1, wherein unit changes comprises identifying, in the URL, a change of one particular type of character to another type of character, not of the particular type.

4. The method of claim 3, wherein types of characters comprise a number, letter or symbol.

5. The method of claim 1, wherein information extraction algorithms comprise TF-IDF.

6. The method of claim 1, wherein information extraction algorithms comprise dictionaries.

7. The method of claim 1, wherein information extraction algorithms comprise mutual information.

8. The method of claim 1, wherein information extraction algorithms are based on measures from information theory.

9. The method of claim 1, wherein regular expressions are stored in an indexing structure.

10. The method of claim 1, wherein regular expressions are stored in the form of any of: a suffix tree, a trie, or a prefix tree.

11. The method of claim 1, wherein regular expressions are stored in the form of a custom index structure.

12. A computer-readable storage medium carrying one or more sequences of instructions which, when executed by one or more processors, causes the one or more processors to:
generate, based upon tokenizations of a URL corpus, regular expressions for URLs in the URL corpus;
receive a particular URL of a web document;
determine whether the particular URL corresponds to any of the regular expressions generated from the URL corpus;
if the particular URL does not correspond to any of the regular expressions generated from the URL corpus, then
(a) tokenize, based on delimiters and unit changes, the particular URL, and
(b) store each token of the particular URL as a keyword, thereby generating a first set of keywords;
if the particular URL corresponds to at least one of the regular expressions generated from the URL corpus, then
(a) retrieve a regular expression associated with the URL that corresponds to the particular URL, and (b) extract, based upon the regular expression, keywords from the particular URL, thereby generating a second set of keywords;
rank, based upon an information extraction algorithm, keywords from one of the first set and the second set, thereby producing a ranked set; and
store the ranked set.

13. The computer-readable storage medium of claim 12, wherein delimiters comprise “/,” “?,” “&,” and “=”.

14. The computer-readable storage medium of claim 12, wherein unit changes comprises identifying, in the URL, a change of one particular type of character to another type of character, not of the particular type.

15. The computer-readable storage medium of claim 14, wherein types of characters comprise a number, letter or symbol.

16. The computer-readable storage medium of claim 12, wherein information extraction algorithms comprise TF-IDF.

17. The computer-readable storage medium of claim 12, wherein information extraction algorithms comprise dictionaries.

18. The computer-readable storage medium of claim 12, wherein information extraction algorithms comprise mutual information.

19. The computer-readable storage medium of claim 12, wherein information extraction algorithms are based on measures from information theory.

20. The computer-readable storage medium of claim 12, wherein regular expressions are stored in an indexing structure.

21. The computer-readable storage medium of claim 12, wherein regular expressions are stored in the form of any of: a suffix tree, a trie, or a prefix tree.

22. The computer-readable storage medium of claim 12, wherein regular expressions are stored in the form of a custom index structure.
